(19) United States
(12) Patent Application Publication
(10) Pub. No.: US 2014/0207691 A1
(43) Pub. Date: Jul. 24, 2014

(54) SYSTEM AND COMPUTER PROGRAM FOR REMOTELY TRACKING AND MANAGING CINEMA ASSETS AND CONTENT

(71) Applicants: Guillermo Younger, MIAMI BEACH, FL (US); LUIS NAGAKI, MIAMI, FL (US); ALEXANDER YOUNGER, MIAMI, FL (US); CORNELIUS PITTS, MIAMI, FL (US)

(72) Inventors: Guillermo Younger, MIAMI BEACH, FL (US); LUIS NAGAKI, MIAMI, FL (US); ALEXANDER YOUNGER, MIAMI, FL (US); CORNELIUS PITTS, MIAMI, FL (US)

(21) Appl. No.: 14/221,498

(22) Filed: Mar. 21, 2014

(51) Int. Cl. G06Q 10/00

(52) U.S. Cl. CPC G06Q 10/20
USPC 705/305

(57) ABSTRACT

The invention is directed to a system and computer program for tracking and managing cinema assets and content remotely by a user. The computer program on a non-transitory computer readable medium, for execution by a computer or application server, comprises a consumables code segment, an assets code segment, and a features code segment. The consumables code segment is configured to track and display of at least one consumable asset. The assets code is configured to track and display hardware information of at least one hardware asset. The features code segment is configured to track and display content information of the media being played on at least one hardware asset. Embodiments of the present invention may further include integrated point of sale, calendar, support, administrative, notification, analytics and messaging code segments.

### BACKGROUND OF THE INVENTION

1. Field of the Invention

The present invention generally relates to a system and computer program for the remote tracking and management of cinema assets and content. Specifically, a user may track the status of various devices within a cinema, and manage the maintenance of such devices. A user may also be able to track and manage digital content and licenses stored for playback on the various devices.

2. Description of the Related Art

The field of cinema management has primarily been concerned with two distinct operational branches, namely asset management and content management.

Asset management primarily relates to the monitoring and maintenance of various hardware devices and consumable assets, such as servers, projectors, media blocks, lamps, filters, and storage media. Each of these devices and/or consumables require varying degrees of oversight and scheduled maintenance. Accordingly, cinema owners devote a substantial amount of time and resources to the monitoring, upkeep, and maintenance of various cinema assets, in order to prevent and/or resolve cinema interruptions.

Content management relates to the management of media content, such as movie features and advertisements. Presently, media content are transmitted to cinemas encrypted, along with separate license keys for decryption during show time. Cinema owners are thus also required to devote substantial time and resources to the organizing and scheduling of various media content and their respective license keys for different cinemas and/or auditoriums having different hardware devices that must be individually configured.

The maintenance of the various hardware devices, consumable assets, and media content are presently and predominantly manually driven, and must also be conducted on site at each cinema and/or auditorium location. The manual tracking of the mass of information is difficult and often lead to cinema interruptions, such as inadvertent hardware or consumable outages, or forgotten or incorrect license key placements.

Accordingly, by leveraging an automated system and computer program for the monitoring, maintenance, scheduling of various cinema assets and content, the present invention allows for the management of cinema(s) as to both assets and content remotely and efficiently. Further, by predicting common theater problems with analytical data and device information, the present invention is able to catch eventual problems before they occur and allow a user to take necessary actions well in advance, thus mitigating the chance of any cinema operation interruptions.

### SUMMARY OF THE INVENTION

The present invention is generally directed to a system and computer program for the remote tracking and management of cinema assets and content, whereby a user may track the status of various devices within a cinema, and manage the maintenance of such devices as well as their media content. Accordingly, it is an object of the present invention to increase efficiency in cinema management, and to minimize downtime through the intelligent and active monitoring and notification of various required or recommended actions, to eliminate any emergency maintenance or other situations that may interrupt cinema operations.

In initially broad terms, a system of the present invention may comprise an application server accessible from a plurality of remote devices and in communication with a plurality of cinema assets. The application server comprises a computer program having a plurality of code segments directed to various features outlined in more detail below. The computer program may thus comprise a consumables code segment, a features code segment, a support code segment, an assets code segment, a calendar code segment. The computer program may further comprise a point of sale code segment, notification code segment, analytics code segment, administrative code segment, and a messaging code segment.

The consumables code segment is configured to track and display usage of at least one consumable asset, such as a projector lamp, a projector filter, and/or a hard disk. Usage may include the total warranty hours, the hours used, and the hours remaining.

Hours used may be calculated based on approximate averages, or directly from a consumable asset if the consumable asset is appropriately equipped with a sensor and/or other device comprising usage data. Alternatively, hours used may be calculated based on analytical data from an analytics code segment that tracks the average use time and/or expiration time of a particular asset. Consumable information such as model number, serial number may also be provided through this code segment. The consumables code segment may be integrated with a notification code segment such as to flag potential issues by providing notifications of a consumable asset approaching expiration. The consumables code segment may also be integrated with a point of sale code segment such as to allow a user to purchase a replacement or compatible consumable asset within the computer program.

The assets code segments is configured to track and display hardware information of at least one hardware asset, such as a projector, computer or server, and/or media block. Hardware information may include model number, serial number, firmware version, operational status, and/or warranty information. This information may be queried from the hardware asset itself, or may be manually inputted into a local server or the application server. The consumables code segment may be integrated with a notification code segment or feature such as to flag potential issues by providing notifications of an issue with a hardware asset or the expiration of a warranty period. The assets code segment may similarly be integrated to the notification code segment and a point of sale code segment, such as to provide early warning indicators, i.e. increased temperature, fan speed, and to allow a user to purchase maintenance, a replacement asset, and/or purchase additional warranty. The assets code segment may also allow a user to update the firmware of one or more hardware assets remotely.

The features code segment is configured to track, display content information, and effect play operations of various media. Content information may include total run time, current play time, play status, media information, subtitle information, and/or license information. A user may create or modify a play list and/or scheduling of different media to be played at different auditoriums on particular cinema asset(s) or device(s). The features code segment may be integrated with a notification code segment such as to notify a user of an approaching license expiration or faulty license key. The features code segment may be configured to allow a user to extend or renew a license for a content or feature.

The point of sale code segment as described above, may be integrated with one or more code segments, in order to process payment transactions for the purchase of consumable or hardware assets, for the maintenance or warranty of various assets, and/or for the license of media content.

The calendar code segment is configured to display at least one representation of a notification time or time period to a user in a calendar format. The calendar code segment may similarly be integrated with the code segments described above, such as to display the various notifications or time periods.

The support code segment is configured to facilitate communication of support requests between the user and support personnel. The support code segment may be partially integrated with the above code segments such as to automatically provide support personnel with information regarding the status of various assets within a cinema, and for support personnel to push the scheduled maintenance of various assets or the shipping status of various assets to the calendar code segment to be viewed by the user.

The present system and computer program may comprise additional code segments, such as an administrative code segment configured to set permissions of a plurality of users, such that different users may access and maintain various aspects of a cinema or plurality of cinemas. The messaging code segment may be configured to facilitate communication between users within a cinema organization. The analytics code segment may be configured to display historical data of prior usage of various cinema assets, as well as past purchase history. The analytics code segment may be partially integrated with the above code segments in order to predict possible issues or failures. For example, usage or expiration of a consumable asset may be derived from the average usage time of a number of particular cinema asset(s) in aggregate.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a diagrammatic representation of a system for the remote tracking and management of cinema assets and content.

FIG. 2 depicts an example of a user interface for accessing and interacting with a plurality of code segments directed to the computer program for the remote tracking and management of cinema assets and content.

FIG. 3 depicts an example of a user interface for accessing and interacting with the consumables code segment of the computer program of FIG. 2.

FIG. 4 depicts an example of a user interface for accessing and interacting with the assets code segment of the computer program of FIG. 2.

FIG. 5 depicts an example of a user interface for accessing and interacting with the features code segment of the computer program of FIG. 2.

FIG. 6 depicts an example of a user interface for accessing and interacting with the support code segment of the computer program of FIG. 2.

FIG. 7 depicts an example of a user interface for accessing and interacting with the support code segment of the computer program of FIG. 2.

FIG. 8 depicts an example of a user interface illustrating the notification features of the computer program of FIG. 2, showing the particular theater and auditorium with unread notifications.

FIG. 9 depicts an example of a user interface illustrating other menu options.

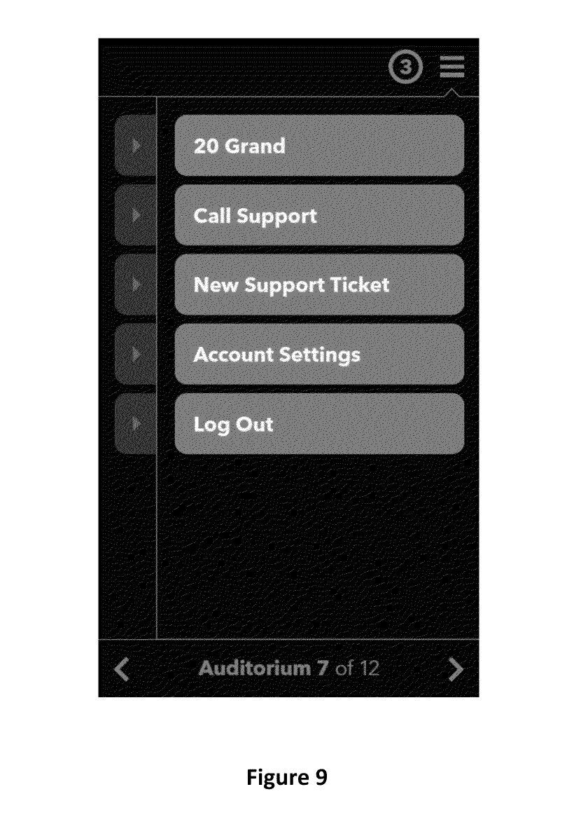

Like reference numerals refer to like parts throughout the several views of the drawings.

### DETAILED DESCRIPTION OF THE PREFERRED EMBODIMENT

As illustrated by the accompanying drawings, the present invention is directed to a system and computer program for the remote tracking and management of cinema assets and content. Specifically, a user may track the health and status of various devices within a cinema, and manage the maintenance of such devices. A user may also be able to track and manage digital content of the various devices through the same system and computer program.

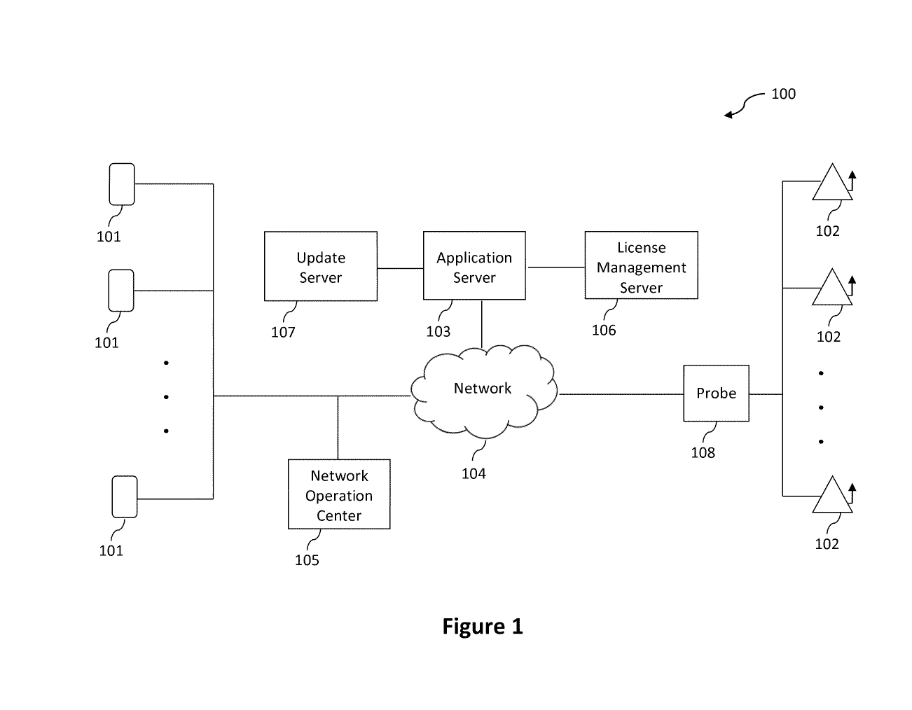

Accordingly, a system 100 of the present invention in accordance with FIG. 1 comprises an application server 103 having appropriate hardware and software, which is accessible from a plurality of remote devices 101, and also in communication with a plurality of cinema assets 102. Various embodiments of the present invention further comprises a probe 108 in communication with a group of cinema assets 102. For instance, a probe may be deployed at each particular geographic location and/or auditorium. The system 100 may further comprise a license management server 106 to facilitate the distribution and renewal of license keys from a cinema studio to individual cinema theaters, as well as an update server 107 to facilitate the distribution of firmware and software updates from the update server 107 to individual cinema assets 102.

The system 100 may also comprise a network operation center 105 structured, configured, and/or staffed to monitor the plurality of theater assets 102. The application server 103, license management server 106, update server 107, and probe 108 may be a general purpose computer, custom computers, custom servers, or a specialized machine, having at least a processor and memory capable of executing at least a portion of a computer application stored on a non-transitory computer readable medium such as a hard disk. The computer application or program comprises a plurality of code segments directed to various features of the present invention described in more detail below.

As such, the present invention may be implemented as a software as a service (SaaS) housed on the application server having appropriate hardware and software. The present invention may be implemented in a number of different solution stacks when deployed as a SaaS. These solution stacks may include, without limitation, Zend Server, XAMPP, LAMP, MAMP, WISA, and other solutions or equivalents known to those skilled in the art. It should thus be understood that the present invention may be implemented using any combination of operating systems, HTTP or other protocol servers, various security protocols (such as SSL), various different database servers, as well as different scripting or programming languages that make up the computer program including its logic, communications, and user interface. The solution may be fully or partially hosted on the application server, and may also be partially hosted or mirrored on a network 104 which may comprise other appropriate hardware, software and communications devices or mediums, such as backup servers, storage servers, content delivery networks, communication via routers, switches, network cables of wireless nodes and networks. Alternatively, the present invention may also be deployed as a software on a disk accessible by a local machine in communication with the remote devices 101 and cinema assets 102, coded in any number of programming languages for various operating systems known to those skilled in the art.

The remote device 101 may comprise a computer, tablet, phone, wearable electronic device, or other mobile device structured and configured to provide a user access to the computer program for tracking and managing movie theater assets and content remotely. Accordingly, at least a portion of the computer program may reside on the remote device 101, such as a mobile application, mobile browser, web browser, or other network or Internet operating system or application configured and appropriate for accessing the computer program. The cinema asset 102 may comprise various hardware assets such as a computer, server, media server, a projector, a media block, digital signage, dispensing machines such as popcorn, candy, and/or drink machines, point of sale devices and/or systems, or other appropriate hardware assets for use in a cinema. The cinema asset 102 may additionally comprise various consumable assets such as projector filters, projector lamps, computer hard disks or other storage mediums for storing media content, and/or food or drink. Accordingly, various cinema assets 102 may be operatively connected to the application server 103 either directly or over the network 104, such as to transmit a signal and/or their operational status to the application server 103.

In at least one embodiment, various cinema assets 102 may be connected first and/or directly to a probe 108 which is in communication with the application server 103 through network 104.

A plurality of probes 108 may be utilized in the present invention, such as a probe 108 being deployed at each particular auditorium and/or cinema location. A probe 108 may comprise at least one server, storage rack, and various sensors for monitoring the status of the storage rack which may comprise a plurality of hard drives in a RAID configuration. The various sensors 108 may also monitor the ambient temperature of the probe 108's environment, such as a room housing the servers and storage rack.

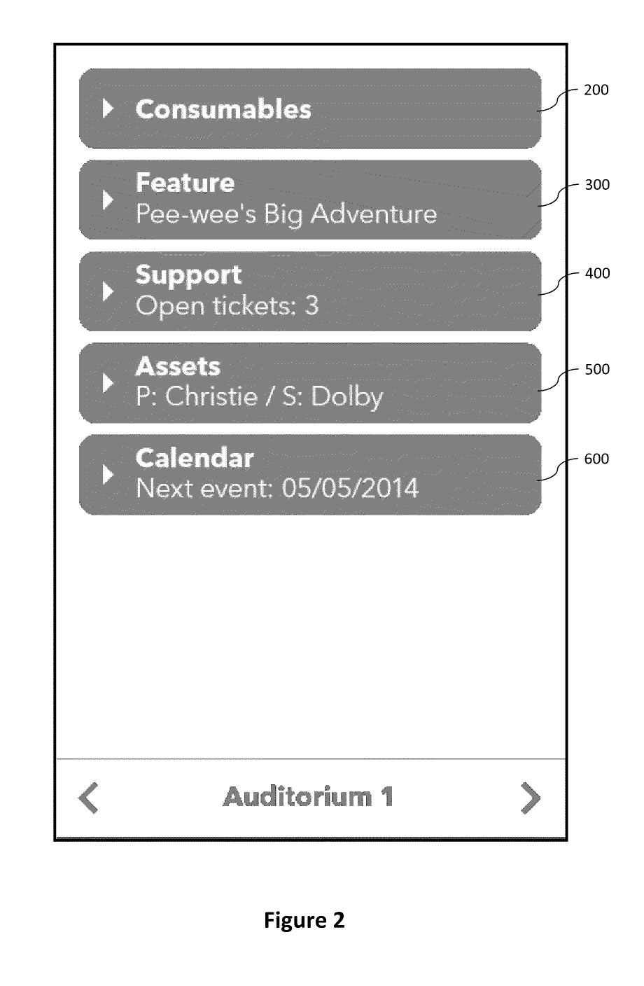

In a preferred embodiment of the present invention, the computer program comprises at least the following code segments, at least one of which may be executed, in any order: a consumables code segment 200, a features code segment 300, a support code segment 400, an assets code segment 500, a calendar code segment 600, as illustrated in FIG. 2. The computer program may also include a point of sale code segment, notification code segment, analytics code segment, administrative code segment, a messaging code segment, and other code segment(s) that may be called upon independently or through the other code segments. The series of screenshots or examples in the accompanying Figures illustrate the functionality of the computer program and various code segments from the point of the user through illustrative user interfaces, and is not intended to be limiting. The programmable logic behind the interface, which supports the functionality of the computer program and code segments, may be implemented by using any number of solutions described above, or as known to the programmers skilled in art. Further, it should be understood that various code segments may share common code functions or libraries and may be partially integrated or tied together through various frontend user interfaces, backend programmable logic, and combinations thereof.

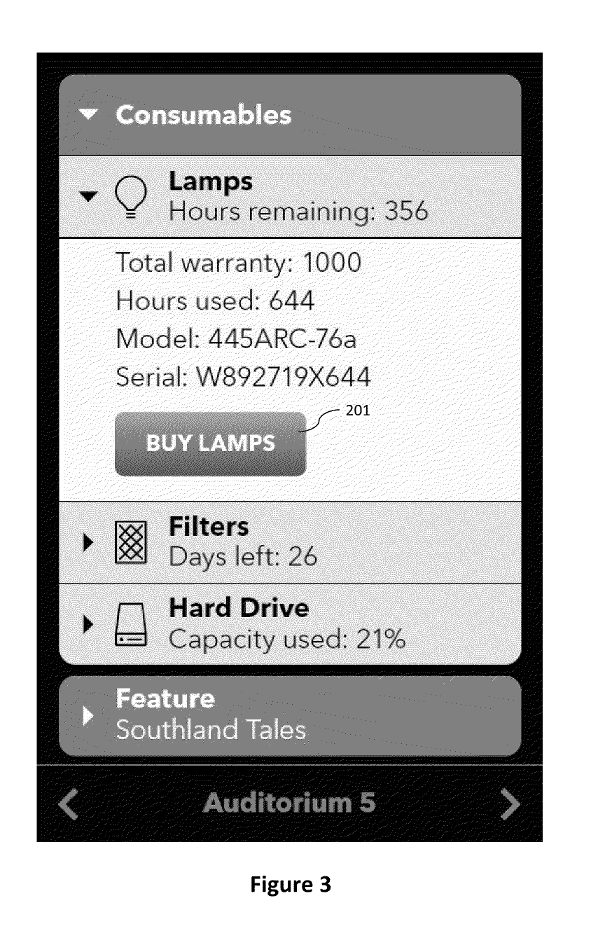

The consumables code segment 200 is configured to track and display usage of at least one consumable asset. As such, the consumables code segment 200 may comprise usage and device information of various consumable assets, as shown in FIG. 3. Consumable assets may include but are not limited to projector lamps, projector filters or other filters, and hard drives or other storage media. Usage information or usage of consumables, such as lamps and filters, may accordingly comprise the total warranty hours, the hours used, and the hours remaining. Usage information for a hard drive may be received directly from the local server or computer. The consumables may also comprise consumables information such as model number, serial number, and other identifying information.

Hours remaining of a consumable asset may be calculated from the total warranty hours minus the hours used. In one embodiment, hours used may be tracked directly from a projector lamp or filter if it comprises a sensor and/or devices capable of recording and transmitting that information to the application server 103. In another embodiment, the consumables code segment 200 may also be configured to calculate the hour usage, such as based on average usage time over a period of time. This information may be manually inputted, or may be calculated using an analytics code segment, which may be configured to calculate and notify a user of an asset's expiration or impending expiration, in accordance to a predetermined set of rules, such as calculating the average usage time of a consumable asset based on aggregate data recorded by the application server 103. For example, the analytics code segment may be partially integrated with the consumables code segment 200, such that an average expiration time of an asset, i.e. a projector lamp, may be calculated from historical data of similar projector devices and/or lamps. The analytics code segment may also be utilized in part to calculate the predicated life span of various other cinema assets, such as hardware assets, and recommend purchases, maintenance, and/or replacements accordingly.

Consumable assets may also include food and/or drink of various hardware dispensaries and/or concession stands in a cinema. For example, appropriate sensors may be placed or embedded into popcorn, candy, or drink machines or dispensaries, which may provide tracking and notifications of the current volume and estimated depletion time. Alternatively, consumable inventory may also be inputted and/or managed manually, such that each cinema or auditorium's respective inventory can be viewed and managed remotely.

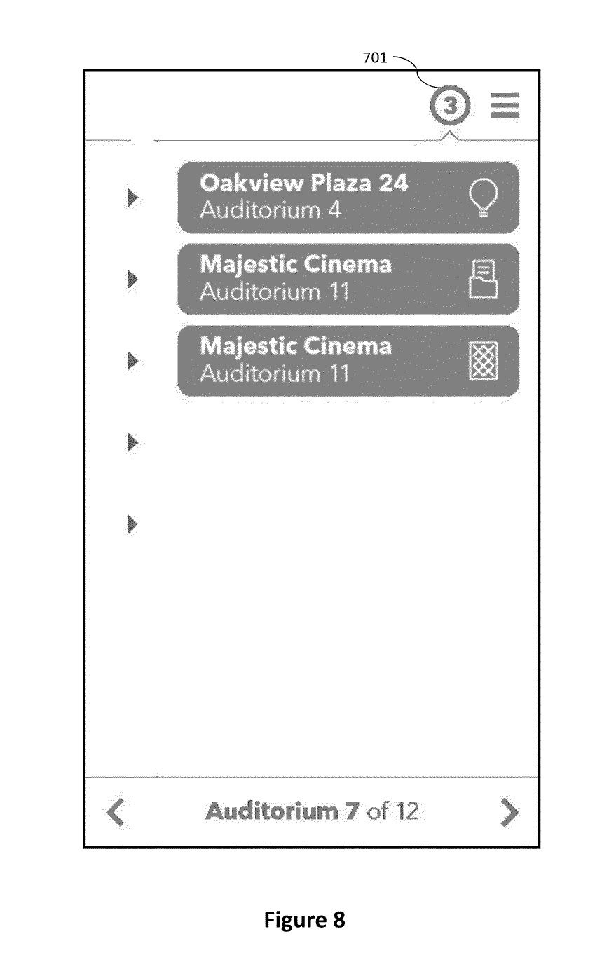

In at least one embodiment, the consumables code segment 200 may be integrated with a notification code segment and/or be configured with notification features, such that a consumable asset approaching expiration will trigger a notice to be sent to the user. The notice may comprise a message transmitted by email, text or SMS, and/or an in application notification such as a push notification or notification mechanism as illustrated in FIG. 8.

As such, a user may navigate from each cinema and/or auditorium down to the particular consumable asset triggering the notification, to view the exact error code or problem indicated.

The user may, after being prompted by the notification, or at other times, purchase replacement consumable assets through the consumables code segment 200, such as through a button 201 or other navigational interface. The user may then be linked to a point of sale application or website, or be directed to the point of sale code segment of the present invention within the same computer program. The point of sale code segment will be at least partially integrated with the consumables code segment 200, such as to pre-populate fields or a shopping cart, and/or recommend purchases based on the current consumables information and/or hardware information, such that only compatible consumables may be recommended to a user. The point of sale code segment may also offer replacement or replenishment of consumable assets on a subscription basis, such that consumable assets, such as projector lamps and filters, are sent to a user or cinema periodically, either based on actual expiration time or predicted expiration time, to ensure the receipt of the consumable assets and avoid theater interruptions and/or prevent periods without warranty coverage.

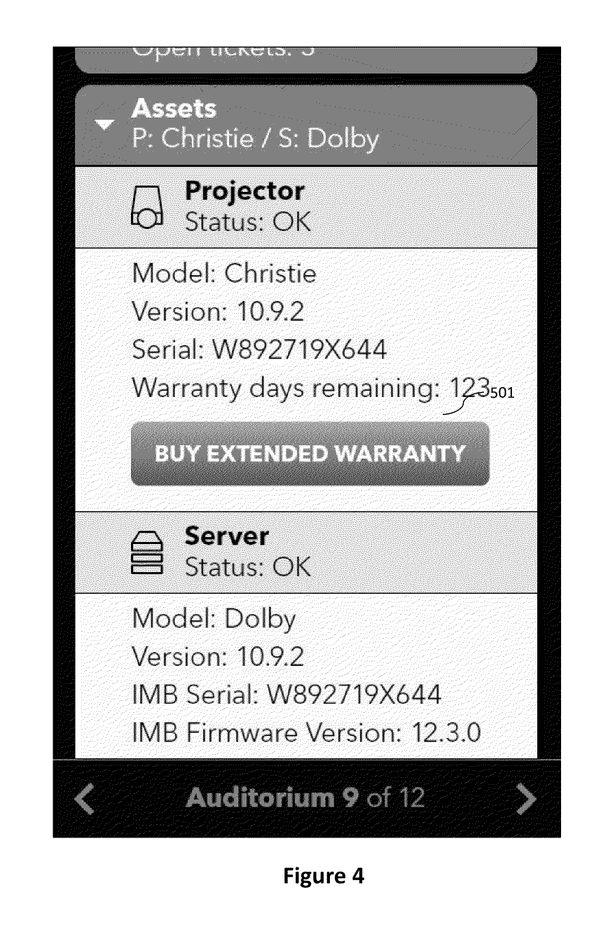

The assets code segment 500, as generally illustrated by FIG. 4, is configured to track and display hardware information of at least one hardware asset. The hardware asset may comprise projectors, server, and/or media blocks, which may be communicably connected to the application server 103 or computer over a network 104, such as to receive a query and transmit hardware information in real time or near real time. Alternatively, in other embodiments, at least a portion of hardware asset information may be stored on the application server 103 or on a system, device, or computer locally near the hardware asset. Hardware information may comprise model number, serial number, firmware version, operational status, and/or warranty information. At least a portion of this information may be queried directly to the hardware asset and transmitted from the hardware asset to the application server 103.

The assets code segment 500 may be integrated with a notification code segment and/or be configured with notification features, as described above. A user may be notified of hardware malfunctions and/or various errors, firmware or software updates, as well as warranty periods and expiration.

In at least one embodiment of the present invention, the assets code segment 500 may be configured to allow for the automatic or partially automatic update of the firmware of one or more hardware assets, such that a user may update at least one hardware asset from a remote device 101, either directly from a manufacturer's server or from the application server 103, network operation center 105, or other server. A user may enable such automatic updating, or alternatively, such updates may be executed upon a user's request. The assets code segment 500 may also be integrated with a point-of-sale code segment as described above, such as to facilitate the purchase or extension of warranty for various hardware assets. A user may access the integrated point of sale code segment through a button or user interface 501.

The application server 103 and the plurality of assets 102 comprising hardware assets and/or consumable assets equipped with sensors may be cooperative structured and configured to provide a real time or near real time health status of the one or more assets. For example, if the asset is operating, an “OK” may result and may be displayed on the plurality of remote devices and/or at the network operation center 105. Accordingly, a predetermined list or database of error codes and signals may be associated to various status messages, including but not limited to hard drive raid status, temperature sensor of server and/or projector, connectivity and power, fan speed sensor, and other sensors and metrics. For instance, an error code or warning message may be generated upon abnormal fan speed, which may prompt a scheduled cleaning, fan or filter replacement, and a user may be notified accordingly through a notification code segment.

It should be understood that information in the user interfaces may be arranged in varying orders. For example, in various embodiments, the consumables code segment 200 and assets code segment 500 may exist as either separate code segments or as a single code segment observable through a user interface by a user, such as accessible via the same or different menus, or being displayed on the same or separate pages or frames.

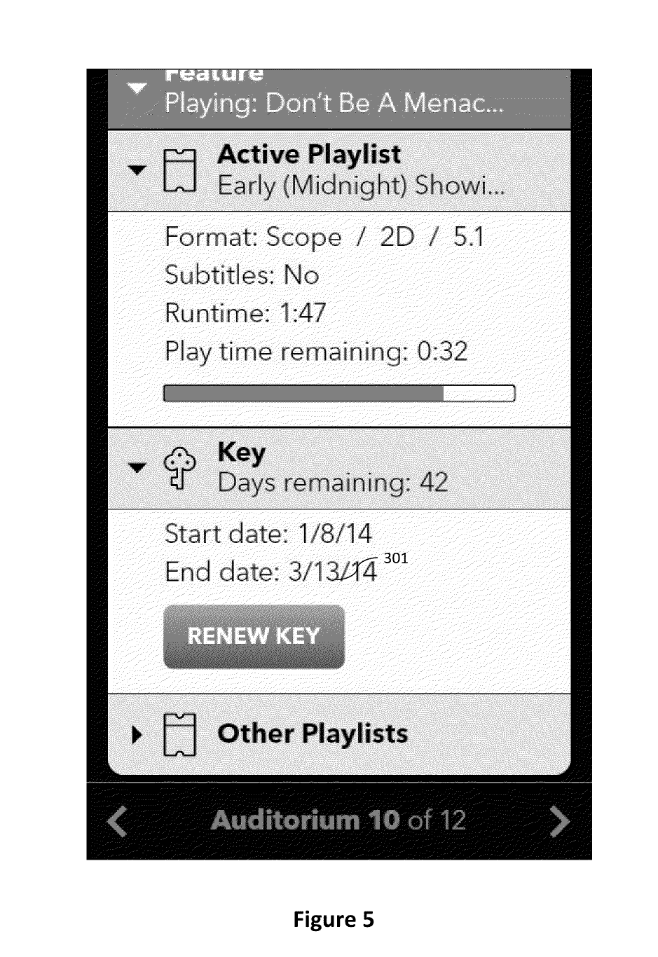

The features code segment 300, as illustrated in FIG. 5, is configured to track and display the content information of media being played on the at least one hardware assets. Accordingly, the application server 103 may be connected to at one cinema asset, such as a media server or a projector, in order to track and display what content is being played, stored, and/or in queue and its respective metadata. Content information may comprise total run time, current play time, play status, media information subtitle information, and/or license information. Media information may further include video and sound information such as format (2D or 3D, number of sound channels), encoding, resolution, and other relevant data. The features code segment 300 may similarly be configured with a notification feature and/or notification code segment to notify a user of an expiring license key or of a faulty license key.

In at least one embodiment of the features code segment 300, a user may create, modify, or otherwise change a play list and/or scheduling of different media to be played at a particular cinema, auditorium, and/or cinema asset(s) or device(s). Accordingly, a user may be able to schedule a series of Composition Play List (CPL) including features and advertisements in a Show Play List (SPL). The features code segment 300 may also coordinate the use of Key Delivery Messages (KDM) or keys or media licenses necessary for the decoding of certain CPLs. Accordingly, the application server 103 and/or the license management server 106 may track the distribution and duration of various licenses. The features code segment 300 may be configured to facilitate the matching and renewal of keys, such as through a user interface button at 301.

Presently network studios allocate keys to cinema owners primarily manually such as by mailing a physical hard drive in connection with the sending of a corresponding media license or key, such as by email from a studio's license distributor. Accordingly, an embodiment of the present invention at least partially automatically pulls information from the distributor email, and then maps the media license to the corresponding feature or media. The features code segment 300 may be configured to automatically check if the key is faulty, and automatically notify a user and/or the studio accordingly. The features code segment 300 will track the duration of the license key and notify a user as expiration approaches or upon expiration of a key. A user may renew or extend the license key from the features code segment 300, such as through user interface button 301. A studio distributor will then make a determination if they will extend the license key.

In one embodiment, such action may then prepopulate or auto-populate an email or form letter to the corresponding studio distributor and contact of the particular content feature. The studio distributor will then make a determination of whether or not to extend the license key. If the distributor chooses to do so, they may send an email including a new license key to the user. Upon receiving a new key for an extended duration, the features code segment 300 may at least partially automatically extrapolate, such as string or field matching, the appropriate data from the email or message and match the new key to the feature and update the remaining duration and/or expiration of that feature. In other embodiments and in place of email, web forms or communications via other protocols may be used.

The point of sale code segment as described above, which may be integrated with the one or more code segments, may be configured to process a payment transaction from the user. The payment transaction may be for goods such as consumable or hardware assets, for maintenance of the various assets, for warranty of the various assets, and/or for the license of media content through the respective code segments described above. The point of sale code segment may utilize various e-commerce payment gateways as known to those skilled in the art, and such transactions may be in the form of a single payment or on a subscription basis.

The calendar code segment 600 is configured to display at least one representation of a notification time, or time period to a user in a calendar format. Accordingly, the calendar code segment 600 may be at least partially integrated with the code segments described above, such as to display notifications or time periods associated with the consumables code segment 200, which may include a consumables expiration date, consumables warranty period, consumables order date, consumables shipping date, and/or scheduled consumables installation date. Similarly, the calendar code segment 600 may also be at least partially integrated with the assets code segment as to display the asset warranty period, asset warranty expiration date, asset error(s) and date(s), and any scheduled asset maintenance date(s) and time(s). A user may be able to schedule service and/or support for a particular cinema asset via the calendar code segment 600, which may automatically populate various fields of the service and/or support request with information regarding the particular cinema asset, such as model, serial number, warranty information, service history, date of last error and/or error code. The calendar code segment 600 may also be at least partially integrated with the features code segment 300, such as to display a representation from the features code segment including a license period of a media and/or its expiration date.

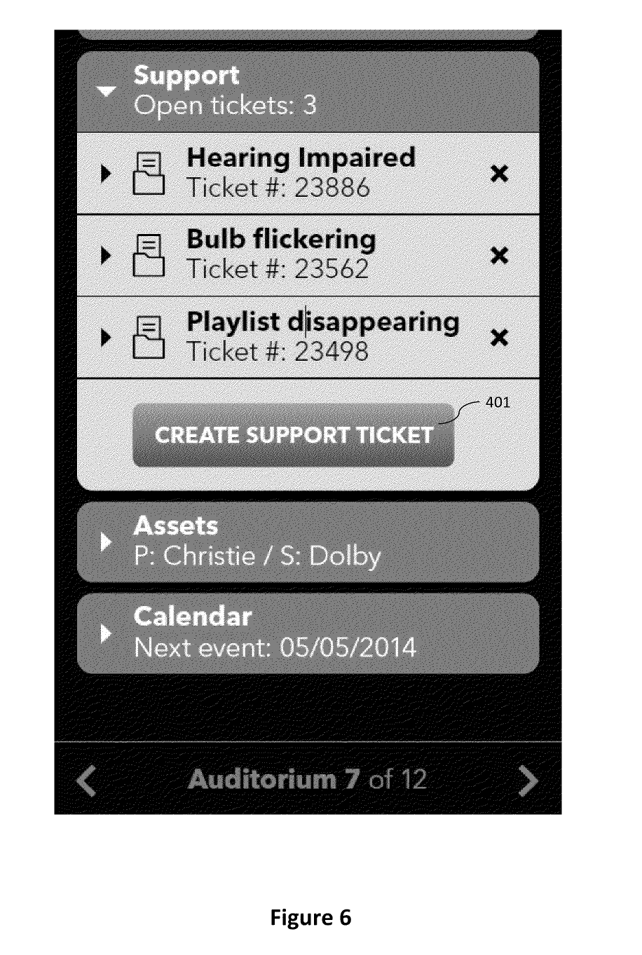

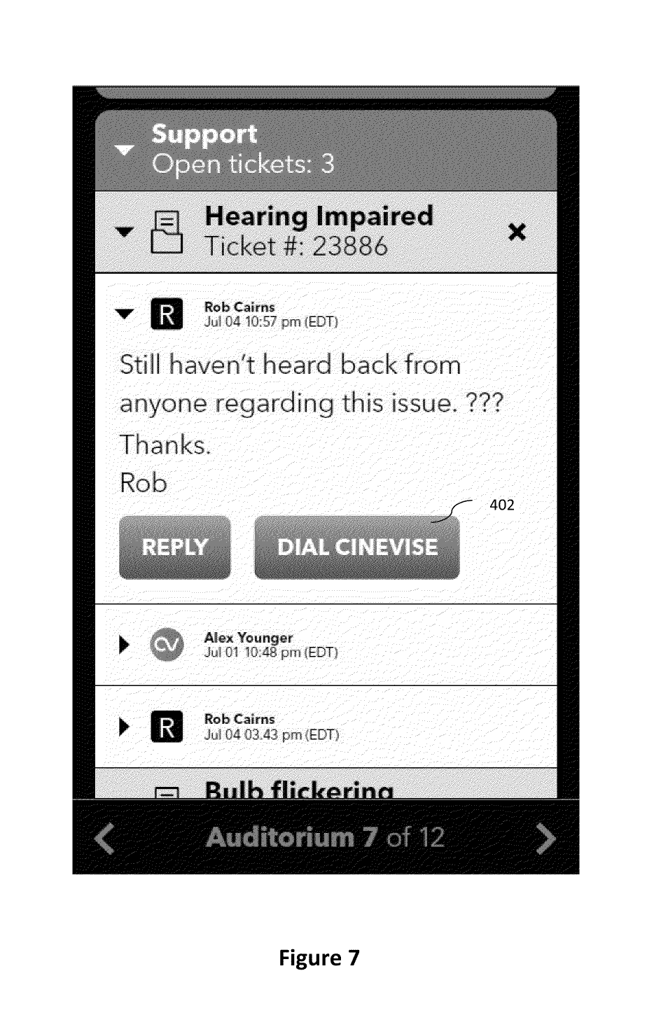

The support code segment 400, as illustrated in FIGS. 6 and 7, is configured to facilitate the communication of support requests between the user and support personnel. Support personnel may be communicable connected to the applications server 103 over network 104 from a network operation center 105 through at least one device or computer, or similarly from a remote device 101 whereby the support personnel may connect to the application server 103 via a support or administrative login and/or credentials. Accordingly, the support code segment 400 comprises a messaging system. From the user's perspective, a user may check on current outstanding support tickets and/or past support tickets. From the support personnel's perspective, support ticket messages may be at least partially integrated with the above code segments, such as to automatically include various metadata and information, e.g. device errors, device information, cinema location, and/or contact information. Support personnel may be able to schedule actions, such as maintenance, shipping of new consumables and/or non-consumable cinema assets, etc. which are under warranty. These actions may then be automatically integrated into the calendar code segment 600 above. Support code segment 600 may also comprise a streamlined communication interface for direct contact, such as by phone, voice and/or video chat, or other means of communication with support personnel and/or with the network operation center 105, such as through the user interface button 402.

The administrative code segment, not shown, may be configured to set permissions of at least one user, such that a plurality of users may access and maintain various aspects of a cinema or group of cinema complexes.

The analytics code segment may be configured to display historical data of prior usage of consumable assets, such as how long each asset lasted. The analytics code segment may further be integrated with the point of sale code segment in order to show the amount of money spent on each particular type of asset, warranty, and/or license, at each particular auditorium and/or cinema location, and/or aggregate amounts thereof. The analytics code segment may be at least partially integrated with the consumables, assets code segments and/or the notification features or code segments. Accordingly, historical data based on equipment issues may serve as an early predictor of possible issues and/or failures, and thus be partially integrated with the consumables and assets code segments to notify the user accordingly.

The messaging code segment may be configured to facilitate communication between a plurality of users within a cinema organization.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A computer program on a non-transitory computer readable medium, for execution by a computer for tracking and managing cinema assets and content remotely by a user, said computer program comprising:
a consumables code segment configured to track and display usage of at least one consumable asset;
an assets code segment configured to track and display hardware information of at least one hardware asset, said at least one hardware asset communicably connected to said computer over a network; and
a features code segment configured to track and display the content information of a media being played on said at least one hardware asset.

2. A computer program as recited in claim 1 wherein said at least one consumable asset comprises a projector filter.

3. A computer program as recited in claim 1 wherein said at least one consumable asset comprises a projector lamp.

4. A computer program as recited in claim 1 wherein said at least one consumable asset comprises a computer hard disk.

5. A computer program as recited in claim 1 wherein said consumables code segment is further configured to notify a user when usage of said at least one consumable asset approaches a predetermined limit.

6. A computer program as recited in claim 5 wherein said consumables code segment is further configured to calculate said predetermined limit based on aggregate analytical data related to said at least one consumable asset.

7. A computer program as recited in claim 1 wherein said at least one hardware asset is selected from a group consisting at least one of a projector, server, and media block.

8. A computer program as recited in claim 1 wherein said hardware information is selected from a group consisting at least one of model, serial number, firmware version, operational status, and warranty information.

9. A computer program as recited in claim 1 wherein said assets code segment is further configured to notify a user when an error occurs on the at least one hardware asset.

10. A computer program as recited in claim 1 wherein said content information is selected from a group consisting at least one of total run time, current play time, play status, media information, subtitle information, and license information.

11. A computer program as recited in claim 1 wherein said features code segment is further configured to create and modify a play list of different media, upon the user's request.

12. A computer program as recited in claim 1 further comprising a point of sale code segment configured to process a payment transaction from the user.

13. A computer program as recited in claim 12 wherein said consumables code segment is further configured to process the sale of at least one consumable asset through said point of sale code segment.

14. A computer program as recited in claim 12 wherein said assets code segment is further configured to process the sale of a product warranty through said point of sale code segment.

15. A computer program as recited in claim 12 wherein said features code segment is further configured to process the renewal of a media license.

16. A computer program as recited in claim 1 further comprising a calendar code segment configured to display at least one representation of a notification time or time period to the user in a calendar format.

17. A computer program as recited in claim 16 wherein said calendar code segment is further configured to display a representation from said consumables code segment, said representation selected from a group consisting at least one of a consumables expiration date, consumables warranty period, consumables order date, consumables shipping date, and scheduled consumables installation date.

18. A computer program as recited in claim 16 wherein said calendar code segment is further configured to display a representation from said assets code segment, said representation selected from a group consisting at least one of an asset warranty period, asset warranty expiration date, asset error date, and scheduled asset maintenance date.

19. A computer program as recited in claim 16 wherein said calendar code segment is further configured to display a representation from said features code segment, said representation selected from a group consisting at least one of a license period of a media and license expiration date of a media.

20. A computer program as recited in claim 1 further comprising a support code segment configured to facilitate the communication of support requests between the user and support personnel.

21. A computer program as recited in claim 1 further comprising an administrative code segment configured to set permissions the user.

22. A computer program as recited in claim 1 further comprising an analytics code segment configured to display historical data of prior usage of consumable assets.

23. A computer program as recited in claim 1 further comprising a messaging code segment configured to facilitate communications between a plurality of users.

24. A system for tracking and managing cinema assets and content remotely by a user, said system comprising:
an application server communicably connected to at least one cinema asset and at least one remote device over a network;
said application server comprising a computer program on a non-transitory computer readable medium, for execution by said application server, said computer program comprising:
a consumables code segment configured to track and display usage of at least one consumable asset;
an assets code segment configured to track and display hardware information of said at least one hardware asset;
a features code segment configured to track and display the content information of a media being played on said at least one hardware asset; and
said at least one remote device structured and configured to provide the user access to said computer program on said application server.
